(19) United States
(12) Patent Application Publication
(10) Pub. No.: US 2009/0055204 A1
(43) Pub. Date: Feb. 26, 2009

(54) REAL-TIME PLAYER TRACKING

(75) Inventors: Richard Pennington, Reno, NV (US); Binh T. Nguyen, Reno, NV (US); Javier Saenz, Reno, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 11/844,262

(22) Filed: Aug. 23, 2007

(51) Int. Cl. G06F 17/30; G06K 9/62; G06Q 10/00; H04N 5/232

(52) U.S. Cl. 705/1; 348/169; 382/103; 382/115; 382/118; 707/104.1

(57) ABSTRACT

Some implementations of the invention provide methods, devices and systems for acquiring patron data in real time. A plurality of networked cameras may be used to acquire information regarding casino patrons. The cameras may include “smart cameras” having an integrated machine vision system. The real-time information may be used to populate one or more databases of a player loyalty program. Patron information may also be used to determine trends associated with patron demographics, with levels of a player loyalty program, etc. Some implementations of the invention involve monitoring patron event data and determining when predetermined events of interest occur. When a defined event occurs, patron data relating to the associated patron may be monitored, analyzed and used to populate one or more player loyalty databases. In some implementations, patron data acquired prior to the time of the defined event may also be analyzed and used.

### CROSS-REFERENCE TO RELATED APPLICATION

This application is related to U.S. patent application Ser. No. ______, entitled “Multimedia Player Tracking Infrastructure” (attorney docket number IGT1P408/P-1221) and filed on Aug. 23, 2007, which is hereby incorporated by reference.

### FIELD OF THE INVENTION

The present invention relates generally to player tracking services and systems.

### BACKGROUND OF THE INVENTION

Player tracking programs (also known as player loyalty programs) are offered at gaming establishments for various reasons, including the desire to attain and/or maintain a player's interest in game play. (Although there are many types of gaming establishments, including casinos, cruise ships, riverboats, etc., all types of gaming establishments may be referred to herein as “casinos.”) Player tracking programs provide rewards to players that typically correspond to the player's level of patronage, e.g., to the player's playing frequency and/or total amount of game plays at a given casino. Player tracking rewards may include free meals, free lodging and/or free entertainment. Some such complimentary rewards are often referred to as “comps.” Player tracking rewards may help to sustain a game player's interest in additional game play during a visit to a gaming establishment and may entice a player to visit a gaming establishment to partake in various gaming activities.

Player tracking programs may be applied to any game of chance offered at a gaming establishment. In particular, player tracking programs are very popular with players of mechanical slot gaming machines and video slot gaming machines. In a gaming machine, a player tracking program may be implemented using a player tracking unit installed in the gaming machine and in communication with a remote player tracking server.

Casinos may use player loyalty programs to gather information regarding patrons that may be used for marketing and provide better customer services. In particular, casinos generally seek to identify certain groups of patrons identified as especially valuable to the casinos and to provide a higher level of service to such patrons. Therefore, player loyalty programs have become important marketing and customer relations tools for casinos.

Casinos may also use player loyalty programs to generate “brand” loyalty. Such loyalty may arise due to the fact that the programs allow a casino to identify and reward patrons based upon their previous game play history. Moreover, after accumulating points in a casino's player loyalty program, patrons may feel that they have made an investment of time and money that will continue to reap benefits if they continue to patronize the casino.

Gaming establishments are continually searching for new and innovative techniques to track patron activity to improve casino operations and marketing. Prior art player loyalty systems have limitations, e.g., regarding a casino's ability to profile players, analyze trends and determine incentives that will build player loyalty. It would be desirable to provide more versatile player tracking methods and devices.

### SUMMARY OF THE INVENTION

Some implementations of the invention provide methods, devices and systems for acquiring patron data in real time. For example, a plurality of networked cameras may be used to acquire information regarding casino patrons. In some such embodiments, some or all cameras in the network may be “smart cameras” that include an integrated machine vision system or the like.

The real-time information may be used to populate one or more databases of a player loyalty program. Some such information may be associated with individual patrons and may, for example, be associated with a member of a player loyalty program. Patron information may also be used to determine trends associated with patron demographics, with levels of a player loyalty program, etc.

Some implementations of the invention involve monitoring patron event data and determining when predetermined events of interest occur. A predetermined event may be referred to herein as a “defined event” or the like. The defined event may involve a certain wagering and/or “coin in” level, the insertion of a player loyalty card into a wager gaming machine, etc. Accordingly, the defined event may or may not be associated with a patron who is known to be member of a player loyalty program. According to some such implementations, when a defined event occurs, patron data relating to the associated patron may be monitored, analyzed and used to populate one or more player loyalty databases. In some implementations, patron data acquired prior to the time of the defined event may also be analyzed.

Some embodiments of the invention provide a system for providing gaming services. One such system includes a camera system comprising a plurality of cameras configured for obtaining patron data regarding people in or near a gaming establishment. The plurality of cameras is preferably configured for communication with other devices via a network.

Some systems of the invention include a plurality of servers and/or other devices that can provide functions such as player loyalty functions, player identification functions, player location functions, storage and retrieval of real-time player tracking data, etc. Device functionality may be apportioned by grouping or dividing tasks in any convenient fashion. Therefore, when steps are described herein as being performed by a single device (e.g., a single server), the steps may alternatively be performed by multiple devices and vice versa.

Accordingly, such a system may also include a server that comprises at least one network interface configured for communication with the network and a logic system. The logic system may include one or more logic devices, such as processors, programmable logic devices or the like. The logic system may be configured to do the following: acquire patron data regarding a patron from at least one of the cameras via the network interface; categorize the person with reference to the acquired patron data; and determine, according to the categorization, whether to populate a player loyalty database with at least some of the patron data.

The logic system may be further configured to cause a benefit to be provided to the patron according to a categorization. The logic system may be further configured to obtain stored patron data regarding the patron from a database and to categorize the patron with reference to the acquired patron data and the stored patron data. The database may, for example, be a player loyalty system database.

The logic system may determine the patron's expected economic value to the gaming establishment. The person may be categorized, at least in part, according to the expected economic value. The logic system may assign a rank to the patron. The rank may depend, at least in part, on the patron's expected economic value to the gaming establishment.

The camera system may be configured for tracking patrons. In some implementation, the camera system may be configured for tracking patrons automatically. The camera system may include apparatus configured for handing off acquired patron data from a first camera having a first camera range to a second camera having a second camera range. At least some cameras in the camera system may be configured with a logic system configured for controlling the camera to perform, at least in part, some of these functions.

The system may further comprise one or more a location detection devices. For example, some implementations of the invention include a network of radio frequency identification (“RFID”) readers. Such readers may be configured to provide patron locations, e.g., by reading RFID tags associated with patrons. In such instances, a patron location may be determined by associating an RFID tag read with a known RFID reader location.

Alternative implementations of the invention involve methods that may include the following steps: receiving real-time patron event data; comparing the real-time patron event data with a set of defined events; determining when a patron event of the real-time patron event data matches a defined event; and causing real-time patron event data to be stored in a database of a player loyalty system. The set of defined events comprise indicia of patrons with expected economic value to a gaming establishment. The real-time patron event data may relate to a selected patron whose event matched a defined event.

The method may further comprise the step of retrieving, after the determining step, stored patron event data for the selected patron corresponding to a predetermined time interval prior to a time of the defined event. The stored patron event data may comprise image data. The method may also involve receiving selected patron event data that have been selected from the stored patron event data and causing selected patron event data to be stored in the database of the player loyalty system.

The method may also involve associating patron event data that occurred prior to a time of the defined event with the selected patron and storing data associated with the selected patron in the database of the player loyalty system. For example, if a defined event (or the like) indicates heightened interest in a patron, stored video data indicating the patron's prior actions may be reviewed. If additional patron events of interest come to light as a result of such a review, comments regarding such events may be added to a database. Accordingly, real-time patron event data stored in the database may correspond to patron events that occur before or after the time of a defined event. The real-time patron event data may comprise image data, comments or other data.

The determining step may comprise determining that a patron's wagering or coin in has exceeded a predetermined threshold, determining that a member of the player loyalty system has initiated a wager gaming session and/or determining that the member has attained at least a predetermined level of the player loyalty system.

The method may involve associating a code with a patron whose event matches a defined event. The code may comprise an identification code or the like. The code may be associated with a patron's rank or category. For example, the code may be associated with a patron's expected economic value to a gaming establishment.

The method may also involve determining when the patron event data matches a benefit event associated with providing a benefit to the patron and sending a signal to a device via the interface system. The signal may indicate a benefit to be provided to the patron.

Alternative methods are provided herein. Some such methods involve the following steps: acquiring image data of people in or near a gaming establishment; analyzing the image data according to a first rule set; determining whether a person is a member of a player loyalty program; and analyzing the image data according to a second rule set when it is determined that the person is a member of the player loyalty program.

The player loyalty system may comprise a card-based player tracking system. The determining step may comprise determining when the person's player loyalty card has been inserted into a wager gaming machine.

The step of analyzing the image data according to the second rule set may involve a more detailed analysis of stored image data acquired prior to a time at which it was determined that the person is a member of the player loyalty program. At least one of the rule sets may involve one or more of wagering indicia, clothing indicia, jewelry indicia, personal association indicia, tipping indicia and/or purchasing indicia.

The method may involve tracking the person's location while the person is within, or in the vicinity of, the gaming establishment. The method may also involve populating a data file with data regarding the member of the player loyalty program. The data may be image data and/or may be determined according to image data.

Alternative implementations of the invention provide an apparatus, comprising: an interface system; a memory having a data structure stored therein, the data structure indicating a set of defined events; and a logic system. The logic system may include one or more logic devices, such as processors, programmable logic devices or the like. The logic system may be configured to do the following: receive real-time patron event data via the interface system; compare the real-time patron event data with the set of defined events; determine when a patron event of the real-time patron event data matches a defined event; and cause real-time patron event data to be stored in a database of a player loyalty system. The real-time patron event data may relate to a selected patron whose event matched a defined event.

The logic system may be further configured to retrieve, after the determining step, stored patron event data for the selected patron. The stored patron event data may, for example, correspond to a predetermined time interval prior to a time of the defined event. The stored patron event data may comprise, e.g., image data, patron identity data, comment data or other data. The logic system may be further configured to receive selected patron event data that have been selected from the stored patron event data and cause selected patron event data to be stored in the database of the player loyalty system.

The logic system may be configured to associate patron event data that occurred prior to a time of the defined event with the selected patron and store data associated with the selected patron in the database of the player loyalty system. In some instances, the real-time patron event data stored in the database may correspond to patron events that occurred before after a time of the defined event. The real-time patron event data may comprise image data, such as video data.

The set of defined events may comprise indicia of patrons with expected economic value to a gaming establishment. The determining step may comprise determining that a patron's wagering or coin in has exceeded a predetermined threshold, determining that a member of the player loyalty system has initiated a wager gaming session and/or determining that the member has attained at least a predetermined level of the player loyalty system.

The logic system may be further configured to associate a code with a patron whose event matches a defined event. The code may be an identity code or the like. If the patron is a member of a player loyalty program, the code may be a player loyalty membership code. If the patron is not known to be a member of a player loyalty program, the code may be assigned.

The logic system may be configured to determine when the patron event data matches a benefit event associated with providing a benefit to the patron. The logic system may be further configured to send a signal to a device via the interface system. The signal may indicate a benefit to be provided to the patron.

Alternative systems for providing gaming services are described herein. One such system comprises the following elements: apparatus for acquiring image data of people in or near a gaming establishment; apparatus for analyzing the image data according to a first rule set; apparatus for determining whether a person is a member of a player loyalty program; and apparatus for analyzing the image data according to a second rule set when it is determined that the person is a member of the player loyalty program.

The player loyalty system may comprise a card-based player tracking system. The determining apparatus may comprise apparatus for determining when the person's player loyalty card has been inserted into a wager gaming machine.

In some circumstances, the apparatus for analyzing the image data according to the second rule set may perform a more detailed analysis of stored image data acquired prior to a time at which the determining means determines that the person is a member of the player loyalty program. At least one of the rule sets may involve one or more of wagering indicia, clothing indicia, jewelry indicia, personal association indicia, tipping indicia and purchasing indicia.

The system may further comprise apparatus for tracking the person's location while the person is within, or in the vicinity of, the gaming establishment. The tracking apparatus may involve, for example, an RFID system, an system of “smart cameras,” etc. The system may further comprise apparatus configured for populating a data file regarding the member of the player loyalty program according to the image data.

### BRIEF DESCRIPTION OF THE DRAWINGS

FIG. 1 depicts a simplified example of a gaming establishment and related devices that may be used for some implementations of the invention.

FIG. 2 is flow chart that outlines steps of some methods of the invention.

FIG. 3 is a table that indicates one example of ranking and categorizing patrons.

FIG. 4 is a flow chart that outlines a method of the invention.

FIG. 5 illustrates a gaming network that may be used for some implementations of the invention.

FIG. 6 is a block diagram of an Arbiter and other devices that may be used for some implementations of the invention.

### DESCRIPTION OF THE PREFERRED EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

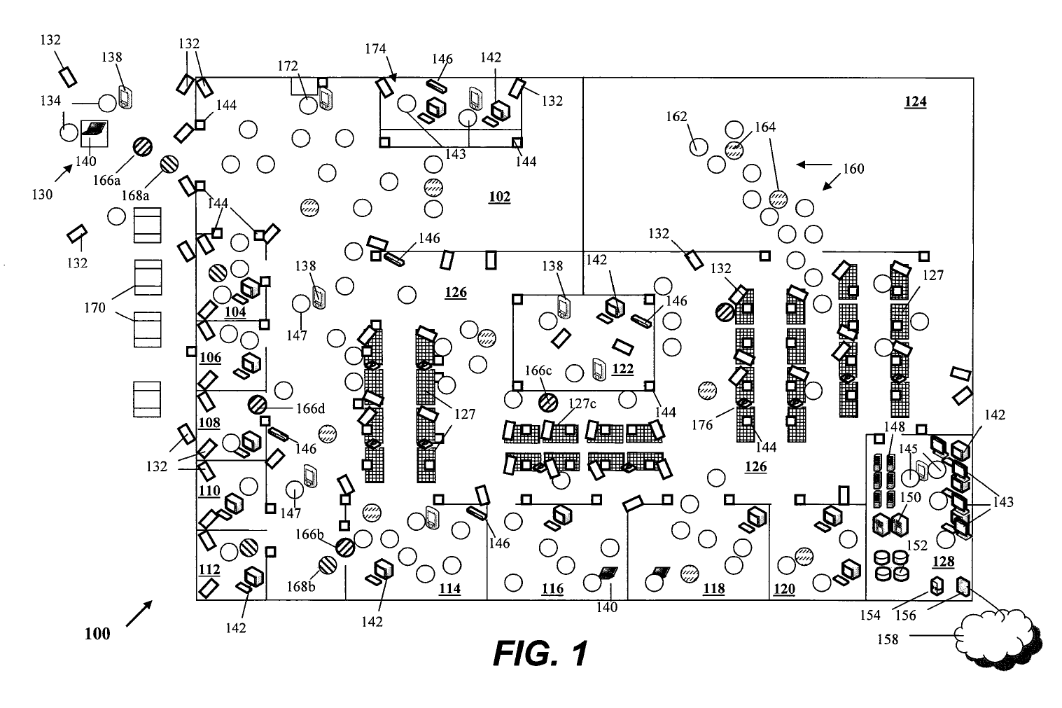

FIG. 1 depicts a simplified example of a casino configured for implementing some aspects of the invention. It will be appreciated the layout, the numbers and types of cameras, gaming machines and other devices, shops, etc., is purely for the sake of example and that other layouts, etc., are within the scope and spirit of the invention. Other camera layouts that may be used for implementing the present invention are discussed in the “Multimedia Player Tracking Infrastructure” application, which has been incorporated herein by reference.

In this example, gaming establishment 100 includes valet area 130, lobby 102 and nearby shops 104, 106, 108, 110 and 112. These shops may include a range of retail establishments, including but not limited to souvenir shops, jewelry stores, clothing stores and the like. Food and beverage establishments 114, 116, 118 and 120 may include restaurants, sushi bars, buffets, or any such dining and/or drinking establishment.

Bar 122 is an island in the midst of the main casino/gaming area 126 that includes various gaming machines 127. Preferably, at least some of gaming machines 127 are configured for communication with other devices, including but not limited to one or more of servers 148, in order to provide various features discussed elsewhere herein. Auditorium 124 includes a stage and seating (not shown) for live performances. At the moment indicated in FIG. 1, a number of patrons 160 are exiting auditorium 124.

Operators 145 and various devices for providing services and managing gaming establishment 100 may be seen in control room 128. This area includes host devices 142 to facilitate the communication of operators 145 with various other devices, such as other host devices 142 (which may serve as cash registers, hotel registration terminals, etc.), PDAs 138, laptops 140, gaming machines 127, etc. Host devices 142 may comprise desktop computers, laptops, workstations, or other such devices. Operators 145 may also communicate with other people, including but not limited to casino personnel 147, via PDAs 138, telephones, etc.

Host devices 142 (and other devices, as needed) are also configured for communication with servers 148, computing devices 150, storage devices 152 and external network 158, via gateway 154 and firewall 156. Network 158 is the Internet in this example, but may be one or more public or private networks. According to some implementations of the invention, additional storage devices and related devices may be accessed via network 158, e.g., a storage area network (“SAN”) or other types of network storage.

Control room 128 includes a plurality of monitors 143 for, inter alia, receiving image data from cameras 132. Cameras 132 may include, for example, “smart cameras,” closed circuit television (“CCTV”) cameras, closed circuit digital photography (“CCDP”) cameras, range cameras and/or webcams. Accordingly, the image data displayed on monitors 143 may include still digital images, video feeds, freeze-frames, etc. Such image data may be used for various purposes, including not only security purposes known in the art but also some implementations of the present invention.

Servers 148 and/or computing devices 150 may be configured to perform various functions, including but not limited to real-time player tracking and/or player loyalty functions, patron identification functions (including but not limited to biometric functions such as facial recognition functions), patron location functions, licensing, gaming, accounting, security services, etc. These functions may include those known in the art and those specific to the present invention. At least some of servers 148 may be configured for communication with cameras 132 and other devices, in order to provide real-time player tracking functionality and other methods described herein.

Some such implementations involve computer vision, machine vision and/or facial recognition systems. For example, some implementations of the invention leverage the ability of smart cameras. A smart camera is an integrated machine vision system which, in addition to image capture circuitry, normally includes a processor configured to extract information from images without the need for an external processing unit. A smart camera generally includes an interface system for communication with other devices. Some smart cameras can identify physical characteristics of individuals, even in a crowd, and track identified individuals as they move through the crowd.

For example, Tyxz, Inc. announced on Dec. 19, 2006 that its DeepSea™ G2 Vision System was able to successfully track visitors to an exhibit at the Smithsonian's Cooper-Hewitt National Design Museum in New York City. The DeepSea™ G2 Vision System may be configured for communication with other devices (e.g., other cameras, devices in control room 128, etc.) via TCP/IP. Accordingly, such smart cameras could provide useful data for implementing some aspects of the present invention.

A facial recognition system is a computer-driven application for identifying a person from one or more digital images. This is generally accomplished by comparing selected facial features in the live image with stored facial recognition data. Facial recognition data (some of which may be referred to as a “faceprint” or the like) may be compared to other types of data for more reliable identification. Such data may include biometric data, such as fingerprint or eye iris recognition data obtained from biometric devices 176 or elsewhere. Some embodiments of the invention provide for biometric devices 176 to gather biometric data unobtrusively, e.g., by including a fingerprint and/or thumbprint reader in one or more control buttons of a gaming machine. According to some implementations of the invention, a tentative patron identification may be evaluated in view of other biometric data, player preference data (e.g., as previously compiled in a player loyalty and/or player tracking database), hotel data, retail data, restaurant/beverage data and/or other data that may be available from other parts of gaming establishment 100 or elsewhere.

Facial recognition algorithms include eigenface, fisherface, the Hidden Markov model, and the neuronal motivated Dynamic Link Matching. An emerging trend uses the visual details of the skin, as captured in standard digital or scanned images. However, two-dimensional face recognition algorithms have shown to be sensitive to changes in lighting, different facial expressions, make-up and head orientation.

Three-dimensional face recognition (3D face recognition) methods involve the three-dimensional geometry of the human face. Some details of recent 3D face recognition methods are described by A. M. Bronstein, M. M. Bronstein and R. Kimmel in “Three-Dimensional Face Recognition” (Intl. Journal of Computer Vision, Vol. 64/1, pp. 5-30, August 2005), which is hereby incorporated by reference. It has been shown that 3D face recognition methods can achieve significantly higher accuracy than their 2D counterparts, rivaling fingerprint recognition in accuracy. Some 3D face recognition techniques involve measuring geometry of relatively rigid features of the face. Other methods use a 3D model to improve accuracy of traditional 2D facial recognition techniques by transforming the head into a known view. Some 3D face recognition methods implement depth perception by projecting a grid onto the face and integrating video capture of the face into a high-resolution 3D model. 3D face recognition methods generally require the acquisition of 3D images, which may require a range camera. Accordingly, the data storage and computational requirements for 3D face recognition methods are likely to be greater than those for 2D methods.

Computing devices 150 may be desktop computers, workstations, blade servers, mainframe computers, supercomputers or other such devices. The type and number of computing devices 150 may be selected according to the speed and number of calculations and other processes that will be required of them. For example, one or more of computing devices 150 (or other devices) may be used for processing data from cameras 132 (such as calculations for facial recognition systems and/or patron tracking), for calculations involved in biometric data analysis and/or other patron identification processes, etc.

In the example illustrated in FIG. 1, a plurality of radio frequency identification (“RFID”) readers 144 are disposed in various locations of gaming establishment 100. RFID readers 144 and related devices may be used, for example, to read and determine the location of a patron's RFID device. Such a device may be a dongle, a bracelet, a “smart card” (which may serve as a player loyalty and/or player tracking card) or another such device. RFID readers 144 and related devices may also be used to determine the location of a portable gaming device that includes an RFID tag, etc. Further examples of how RFID readers 144 and related devices may be used according to the present invention are described elsewhere herein.

Accordingly, some of network devices 146 may be switches, middleware servers and/or other intermediate network devices in communication with RFID readers 144 and at least one of servers 148 that may be configured to provide RFID functionality, such as patron identification and/or location functionality. Depending in part on the size of the gaming establishment(s) involved, the number of RFID readers, etc., it may be advantageous to deploy various RFID-related devices at various hierarchical levels of an RFID network, which may include devices outside of gaming establishment 100. Some such devices and networks are described in “The EPCglobal Architecture Framework: EPCglobal Final Version of 1 Jul. 2005,” which is hereby incorporated by reference. Some network devices 146 may comprise wireless access points for providing a communication link with wireless devices, including but not limited to PDAs 138.

Moreover, one or more of servers 148 (and/or other devices) may be configured to synthesize various types of patron data. For example, one of servers 148 may be configured to determine whether a “read” from an RFID player loyalty device corresponds with the location (and/or identification) of a particular patron whose activities correspond with a defined event of interest to the casino. The server may use the indicated location to synchronize patron tracking data from a smart camera, e.g., by plotting the indicated location on the same display used for a smart camera's patron tracking display.

Other casinos may or may not have RFID readers and/or an associated RFID network. However, most aspects of the present invention can be implemented regardless of whether a casino has these features. For example, a device (e.g., a server) may synchronize camera data and location data in other ways, e.g., by making a correspondence between a known location and an image of the location, e.g., making a correspondence between a known location of a gaming machine and an image of the gaming machine. An operator (or a device, such as a smart camera) could make a correspondence between a patron of interest and an area of a map grid, e.g., a grid displayed on a display screen and superimposed on an image of the casino floor (e.g., an overhead view). In one such example, an operator could indicate a patron of interest by touching an area of a touch screen corresponding to the patron and the location. Further examples are discussed in the “Multimedia Player Tracking Infrastructure” application, which has been incorporated by reference herein.

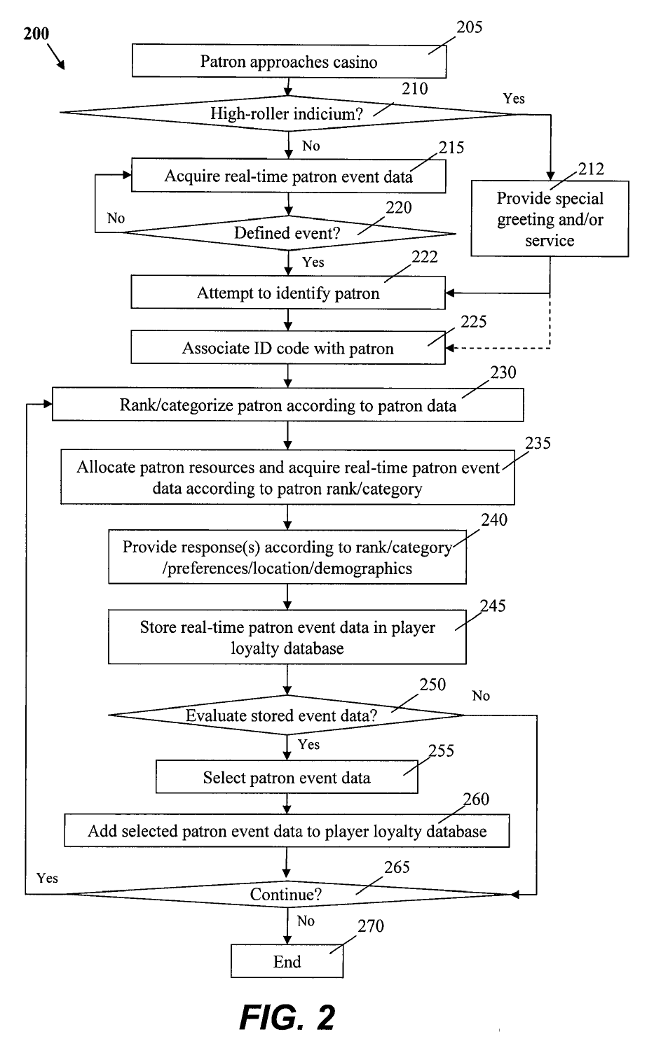

Some implementations of the invention will now be discussed with reference to the flow chart of FIG. 2. It will be appreciated that the steps of method 200 (as with other methods shown and described herein) are not necessarily performed in the order indicated. It should also be understood that the methods of the invention may include more or fewer steps than are indicated. Moreover, while gaming establishment 100 of FIG. 1 will be used to provide examples of method 200, this method is not limited to the devices, layout and/or general configuration of gaming establishment 100. For example, some preferred implementation of the invention involve practicing method 200 (or the like) in a gaming establishment having a camera layout such as those shown and described in the “Multimedia Player Tracking Infrastructure” application, which has been incorporated by reference herein.

In step 205, a patron approaches a gaming establishment. For example, a patron may arrive in one of cars 170 depicted in FIG. 1. In general, a patron's identity will not be known at this time. However, there may nonetheless be indications that the patron may be relatively more likely than other patrons to spend a significant amount of money while visiting the gaming establishment. Such a patron may be referred to herein as a “potential high roller” or the like.

The evaluation of such indications, if any, takes place in step 210. For example, the patron may arrive in a particularly expensive automobile. The patron (or the patron's companion(s)) may be wearing an expensive watch, expensive clothing and/or expensive jewelry. Relevant observations may be made by a human being and/or by one or more devices according to images received by cameras 132. Accordingly, step 210 may be performed, at least in part, by one or more valet attendants 134, operators 145 and/or by devices used by such persons.

However, in some implementations of the invention, step 210 (and possibly other steps of method 200) other may involve automated processes. For example, one or more devices (e.g., servers 148 of control room 128) may be configured to recognize certain patterns associated with high rollers, such as the logo, shape, etc., of a particular automobile in an image captured by one of cameras 132. Such a device may be configured, for example, to recognize a Mercedes Benz, BMW or Porsche and to identify the driver (and possibly passenger(s)) as high rollers. Similarly, such a device may be configured to recognize a Maserati, Ferrari or Lamborghini and to identify associated patrons as a higher category of high rollers. The device(s) involved in such automated processes may or may not be the same device(s) involved in determining “defined events,” as described below with reference to step 220. Similarly, if the initial evaluation of a patron involves a ranking, e.g., as described in this paragraph, the initial ranking process may or may not be part of step 230.

Alternatively, or additionally, the determination of step 210 may involve other automated processes. For example, one or more of RFID readers 144 may read an RFID tag associated with a player, e.g., an RFID tag disposed on a player loyalty card, dongle or other device. In one such example, one or more of RFID readers 144 near the entrance of gaming establishment 100 may read an RFID tag disposed on a player loyalty card and may provide this information to a player loyalty server in control room 128. The player loyalty server may determine that a patron has attained a high level in the gaming establishment's player loyalty program, e.g., is a “platinum level” player.

If it is determined in step 210 that the patron is a potential high roller, the patron may receive special treatment according to some implementations of the invention. For example, a special greeting and/or special service may be extended to the patron and to the patron's companion(s), if any. (Step 212.)

In the example illustrated in FIG. 1, patron 166a has been identified as a potential high roller. Therefore, patron 166a and companion 168a may receive a special greeting, e.g., from valet personnel 134 and/or bell staff 172. Valet personnel 134, operators 145 (and/or devices involved in performing step 1510) may communicate with bell staff 172 and/or hotel desk staff 173 to facilitate this process. Moreover, if patron 166a and companion 168a will be staying in the hotel of gaming establishment 100 (only the lobby 102 of which is shown in FIG. 1), bell staff 172 and/or hotel desk staff 174 may take care of check-in for patron 166a and companion 168a, escort them directly to their room, etc.

Some high-value patrons may not initially present readily-apparent indicia of wealth, a propensity to spend, etc. Therefore, some amount of patron event data is preferably obtained (step 215) even when no high roller indicium has been determined in step 210. These patron event data are preferably monitored to determine whether a “defined event” has occurred (as determined in step 220). Such patron event data may include, for example, data from a gaming machine, a gaming table, etc. Some defined events may be simply wagers, credits and/or a “coin in” of at least threshold amounts. For example, a casino could define one defined event to be a credit of at least $100 in a gaming machine, the purchase of at least $200 worth of poker chips, a wager of at least $10 on hand of blackjack, etc.

Other examples of defined events may be purchases, tips, or other spending in or around a gaming establishment. These expenditures may or may not be directly related to wager gaming. For example, a defined event may involve a retail purchase of a least a predetermined amount, e.g. of at least $500. A defined event may involve a valet tip of at least $10. A defined event may involve how much a patron spends on food or beverages at a particular meal, within a predetermined time (e.g., at a bar and/or while wager gaming), etc. For example, a defined event may be determined if a patron orders a bottle of wine that costs at least $100, spends more than $200 per person at dinner, spends at least $100/hr. on drinks over a predetermined period of time, etc. Accordingly, a defined event may involve a single expenditure and/or a rate of spending over time.

It will be appreciated that defined events may involve patron events at a plurality of locations in various circumstances, involving a range of possible devices and interactions with various individuals. Accordingly, the determination of step 220 may be based upon information determined via multiple sources, which may include various networks. Examples of such networks include casino-related networks (e.g., wager gaming networks, player loyalty and/or player tracking networks, hotel management networks, retail networks, restaurant, beverage networks and/or entertainment networks) as well as external networks.

The term “patron event data” or the like is used broadly herein to include the actions taken by patrons as well as other data that lead to the identification of a known or potential high-value patron, such as the subsequent discovery of “high roller” indicia. For example, a casino employee may notice (e.g., when a patron pushes up the cuff of his shirt or jacket) that a patron is wearing an expensive, rare or custom-made watch, e.g., a Rolex™, a Patek Philippe™, a Jaquet Droz™, a Tiret Splash™, etc. The employee could send a signal to a device and/or to one of operators 145 in the control room 128 (for example, by using a PDA or the like) indicating the detection of a defined event and identifying the patron in some manner, e.g., according to his location. Image data may be acquired from one or more of cameras 132 and used as input data for the determination of step 220, whether by a device executing a pattern recognition program or by a person, e.g., one of operators 145.

As will be described in more detail below, the detection of a defined event may cause one of various rule sets to be applied by a person and/or a device. Such a rule set may involve the collection of additional patron data and associating the acquired patron data with the corresponding patron. The additional patron data may be acquired at a future time and/or may be determined by analyzing previously-acquired data, such as previously-acquired image data. Moreover, the rule set may involve providing services or other benefits to a patron.

If one or more high roller indicia are determined in step 210 (or if a defined event is detected in step 220), an attempt may be made to identify the patron. (Step 222.) Step 222 may involve human input and/or automated processes. For example, step 222 may involve determining whether the patron can be recognized by one or more of valet attendants 134, operators 145, bell staff 172 and/or hotel desk staff 174. If the player is using a player loyalty instrument while playing a gaming machine, a player may be identified according to a player loyalty account. If not, biometric data, such as facial recognition data, fingerprint data and/or retinal scan data may be used to identify a patron.

Some implementations involve expending different levels of resources for attempting to identify patrons having different levels of high-roller indicia and/or different levels of defined events. Therefore, at least some type of ranking process may take place prior to step 222. For example, if insufficient high-roller indicia are detected in step 210, a standard level of facial recognition data may be acquired in step 222. The type and quantity of data in a “standard level of facial recognition data” is preferably determined by the gaming establishment; various reasonable metrics may be established within the scope and spirit of the invention. For example, enough 2D facial recognition data may be acquired to acquire a “faceprint” according to facial recognition software used by a gaming establishment. Establishing such a “standard level of facial recognition data” may allow a reasonable chance of recognizing and locating the patron if it becomes desirable to do so.

If sufficient high-roller indicia are detected in step 210 (or if a high-value defined event is detected in step 220), a relatively higher level of facial recognition data may be acquired. For example, sufficient image data may be acquired for 3D facial imaging methods and/or for methods that compensate for skin type, as described elsewhere.

In alternative implementations, an identification attempt may be made regardless of whether high roller indicia are determined in step 210 or a defined event is determined in step 220. However, even in such implementations, relatively more resources may be devoted to attempts to identify a patron that appears to be of more economic value to a gaming establishment, e.g., as indicated by high roller indicia and/or a defined event.

If the patron can be identified (at least preliminarily), more information may be determined about the patron, e.g., according to public or private databases. Some such data may be associated with the patron, if so desired.

If a casino includes RFID capabilities and one or more of RFID readers 144 detects an RFID tag, the data read from the RFID tag (sometimes referred to as a “tag read” or the like) may be analyzed to see if there is a correspondence between these data and a known individual. For example, a patron may possess some type of device that bears an RFID tag identifying the patron. The device may be, for example, a player loyalty and/or player tracking device such as a “smart card.” In some implementations, 222 may be performed prior to or during step 210 if, for example, an RFID-enabled player tracking card (or another RFID tag that identifies the patron) is detected as the patron is arriving. In such instances, a patron may be greeted by name in step 212. In such instances, the process may not include an additional identification step, but may proceed from step 212 to step 225 or step 230.

Whether or not a patron is positively identified in step 222, an identification code of some type is preferably associated with the patron. (Step 225.) If a patron is a member of the casino's player loyalty program and is the patron's player loyalty instrument has been detected (e.g., if the patron has inserted a player loyalty card in a gaming machine), the identification code may be the player loyalty account code or a variation of the player loyalty account code. If no known identification code is associated with the patron, a code may be assigned in step 225.

In this way, even if a patron is not a member of the gaming establishment's player loyalty/player tracking program and/or cannot be initially be identified by name, data regarding the patron may nonetheless be gathered and associated with that patron. Some patrons may prefer not to be identified by name and may seek some degree of anonymity. Accordingly, the present invention allows players to remain un-identified by name, yet still allows a gaming establishment to identify patrons of interest, gather data regarding them and differentiate the treatment of patrons accordingly.

In RFID-enabled implementations, if a patron has an RFID tag that cannot be identified, the tag read data may be used as the ID code or associated with another ID code that is assigned by gaming establishment 100. Any such RFID tag may be used to identify and locate a patron within a network of RFID readers 144, including but not limited to an RFID tag for an article worn or carried by the patron. An ID code may be associated with other patron identification data such as image data, facial recognition data, voice data and/or other biometric data.

In some implementations, an estimate is made regarding the likely value of the patron to the casino and patrons are categorized and/or ranked accordingly. (Step 230.) Different levels of service/attention/comps may be provided for patrons having different levels of estimated value.

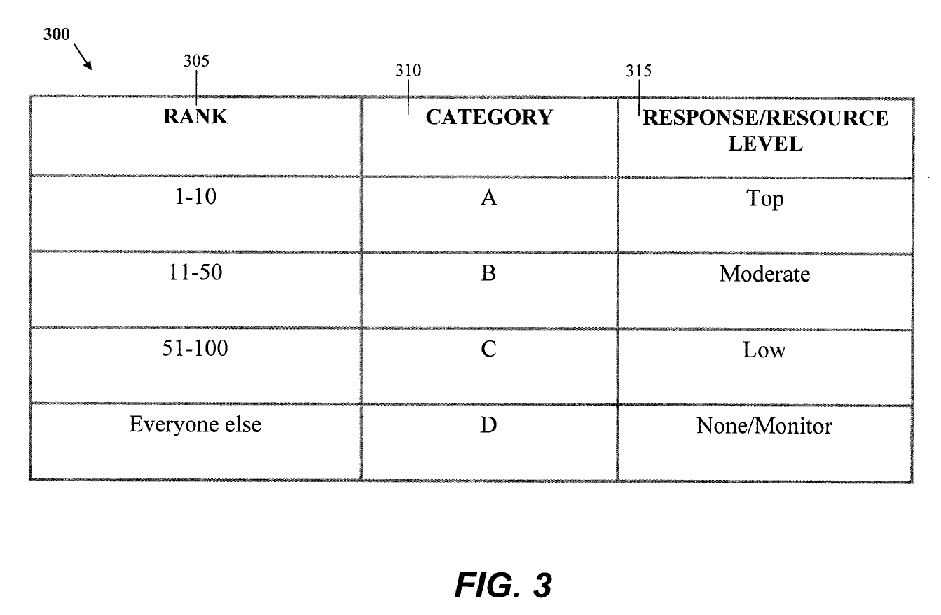

A simple example is illustrated in FIG. 3. Table 300 sets forth ranks 305, categories 310 and response/resource allocation levels 315 according to one implementation of the invention. In this example, the top ten patrons (ranks 1 through 10) are placed in the highest category, “A,” which corresponds to the highest response level. The patrons ranked 11^{th} through 50^{th} are placed in the next category “B,” which corresponds to a moderate response level. Patrons ranked 51^{st} through 100^{th} are placed in category “C,” which corresponds to a lower response level. All other patrons are placed in category “D” unless and until their status changes.

However, in some implementations, there may be a different level of available resources corresponding to each rank. In such implementations, a rank is equivalent to a category.

In still other implementations, there is no fixed number of patrons for at least some of the categories. For example, a patron of the player loyalty and/or player tracking program of gaming establishment 100 may always be entitled to receive (or at least potentially receive) a predetermined level of resources, regardless of the number of other patrons present. In such implementations, a patron who is ranked at the highest level of such a player loyalty and/or player tracking program might always be in category “A” of FIG. 3. Similarly, an anonymous patron who is ranked in a predetermined level according to predetermined criteria/metrics may always be placed in a corresponding category.

Alternatively, or additionally, the number of anonymous patrons present to whom resources will be directed will depend on the number of patrons present who are in a gaming establishment's player loyalty and/or player tracking program. For example, if there are 8 patrons present who are ranked at the highest level of a casino's player tracking program and 30 additional players present who are ranked at the second-highest level of the casino's player tracking program, only 2 anonymous patrons would be eligible to be in category “A” of FIG. 3 and only 10 more anonymous patrons would be eligible to be in category “B.” Anonymous patrons who would otherwise have been placed in category “A” may, for example, be placed in category “B,” to the extent that space is available.

An ID code may convey information about the patron's likely value to the casino. In some implementations, for example, an ID code may include a symbol, a field, etc., indicating a player's current category and/or rank. In such implementations, a patron's ID code may be assigned or updated after a ranking step, e.g., after step 230.

Alternatively, or additionally, an icon, pattern, color, or the like may be associated with player's current category and/or rank, e.g., overlaid on a real-time display of data from one or more cameras, on a map display, etc. For example, players who are currently wagering and/or spending at a high level relative to other patrons may be assigned a characteristic color, e.g., a “hot” color such as red. Other colors in the spectrum may be assigned accordingly, e.g., orange for slightly lower-ranked patrons, yellow for the next level of patrons, etc.

Various types of ranking and/or classification schemes may be employed in step 230, some of which are described in detail herein. In this example, resources are allocated to a patron according to the ranking/classification. (Step 235.) These resources may include patron tracking resources, patron event detection resources, the provision of services, comps, etc. Some examples are provided below.

Although the terms “rank” and “category” may sometimes be used synonymously, in some implementations of the invention the terms may have different meanings. In such implementations, a “category” corresponds to a level of resources that a gaming establishment may potentially direct towards a patron, e.g., according to a method of the invention. There may be several ranks that correspond with a category. In one such example, the top five patrons (ranks 1 through 5) may be placed in the highest category, the patrons ranked 6^{th} through 20^{th} may be placed in the next (lower) category, etc.

As used herein, the term “resources” is used to include time, effort, services, comps, money, etc. In some implementations, the level of resources corresponding with a category may be zero, but this does not mean that a patron will receive, e.g., no service or poor service. Instead, it means that no additional resources, over and above the normal level of service, amenities, etc., will be provided.

A simple classification scheme may place all patrons into one of two categories: (1) patrons worth the dedication of resources; and (2) patrons not worth the dedication of resources. However, alternative implementations of the invention may include multiple gradations of patrons who are deemed to be worth the dedication of resources. For example, there could be N categories of patrons deemed to be worth the dedication of resources, with different amounts of resources that are potentially available to and/or directed towards a patron.

FIG. 1 illustrates one such implementation, wherein N=2. Patrons 166 and their companions 168 are placed in the highest category. For example, patron 166a has exhibited the highest category of high roller indicia (possibly because of the patron's automobile, jewelry, watch, etc.) and has therefore been placed in the highest patron category even before entering gaming establishment 100. Therefore, a high level of resources may be devoted to patron 166a and companion 168a, possibly starting at a time before they enter the casino. Special efforts may be made to provide patron 166a and companion 168a with a high level of service, to acquire patron data regarding their habits and preferences, to identify patron 166a and companion 168a, etc. (Step 240.)

In this example, patron 166c has previously been identified as a high-level patron according to a defined event (step 220) and a ranking/categorization process (step 230). When it is determined that high-level patron 166c is having a drink at bar 122, the beverage preferences of patron 166c are noted in real time, are associated with the patron ID code of patron 166c and are stored as patron data in a player loyalty database. (Step 245.) Moreover, the game preferences of patron 166c are determined (e.g., by reference to the player loyalty database). Gaming machine 127c is configured accordingly (e.g., by a server in control room 128). In some implementations of the invention, multiple nearby gaming machines (e.g., the bank of gaming machines that includes gaming machine 127c) may be configured according to the preferences of a group of patrons (e.g., patron 166c and other patrons nearby). Special promotions (or other responses) may be directed to patron 166c via gaming machine 127c or otherwise, e.g., via a mobile device such as a PDA, a mobile gaming device, a cellular telephone, etc., associated with patron 166c. Preferably, the promotion is tailored according to information regarding the preferences, or at least the demographics, of patron 166c.

In this example, it is observed that high-level patron 166b and companion 168b are at the entrance of restaurant 114. The staff of restaurant 114 is notified that patron 166b and companion 168b should be provided with top-level service. This notification may occur in any convenient fashion, e.g., via cellular phone, PDA, host device 142, etc. For example, patron 166b and companion 168b may be seated even if they do not have a reservation and restaurant 114 is very busy. (Step 240.) They may be provided with free drinks while their table is being prepared. Their food and beverage selections may be noted in real time, associated with their patron ID codes and stored as patron data. (Step 245.) Similarly, when a high-level patron or companion is observed in or near a shop, their purchase types, amounts, etc., may be noted in real time, associated with their patron ID codes and stored as patron data. (Step 245.) High-level service, discounts, free shipping, etc., may be provided. (Step 240.) For example, patron 166d purchased chocolates for a friend at candy store 108. The amount and type of this purchase was noted in real time, associated with her patron ID code and stored as patron data. Patron 166d was pleased when candy store 108 shipped the chocolates to her friend at no charge. (Step 240.) When a high-level patron or companion is observed to be leaving the gaming establishment, he or she may be given a special farewell.

Patrons 164 (two of whom may be seen in auditorium 124) are in the second-highest category. In this implementation, patrons in second-highest category will also receive an elevated level of customer service as compared to the average patron. A more moderate level of patron data will be acquired for in the second-highest category.

Although in theory every patron in a casino could be tracked in real-time, e.g., by cameras 132, some preferred implementations allocate real-time tracking resources (and/or associated patron data analysis and storage) according to patron category and/or rank. (Step 235.) If gaming establishment 100 includes one or more smart cameras with patron tracking abilities, for example, some implementations involve tracking only those patrons in one or more particular categories with the smart cameras. Reducing the number of patrons tracked in real-time allows a casino to dedicate more resources to targeted and potentially higher-value patrons. Therefore, selective real-time tracking allows for a richer data-gathering process regarding the activities of targeted patrons.

For the ranking and categorization scheme of FIG. 3, for example, the casino may decide to track only patrons in categories A and B, or to track only patrons in categories A, B and C. For the previously-described example wherein only 2 levels of patrons received special responses and/or resource allocations, the casino may decide to track only patrons 166 and 164 by the smart cameras.

Some implementations of the invention provide the ability to gather, analyze and store patron event data pertaining to activities that occurred prior to the detection of a high-roller indicium or prior to the determination of a defined event. Certain types of event data may be acquired and stored, at least temporarily, even for patrons that have not yet been identified as having special value to a casino. For example, images may be acquired for all patrons within the range of cameras 132 and stored for a predetermined period of time. If a high-roller indicium is detected or a defined event is determined, activities that occurred prior to the detection and/or determination may be evaluated according by reference to such stored data. Patron event data of interest may be associated with a patron and stored.

In this example, stored event data will be evaluated only for the highest-level patrons 166. Therefore, in this example, the determination of step 250 will comprise a determination of whether a patron is in the highest patron category. If so, stored patron event data will be evaluated, selected (step 255), associated with the corresponding patron and stored. (Step 260.) Here, this process will not be applied for typical patrons or even for patrons 164.

Some implementations of the invention provide for the aggregation of patron data, including patron event data, according to selected patron categories. Patron data that is stored for individual patrons may be analyzed to determine characteristics of patrons in a similar category, e.g., a similar age range, player loyalty program level, wager gaming characteristics (e.g., game type preference, wager/denomination level, volatility preferences, etc.), favorite beverage (e.g., beer drinkers, wine drinkers, Scotch drinkers, Cosmo drinkers), level of retail spending, level of food and/or beverage spending, etc. Such characteristics may be used for various purposes, e.g., for predictive modeling of future events, to make an educated guess regarding the preferences of a patron for whom relatively little is known, etc.

Depending on the amount of data to be evaluated and potentially stored regarding patrons, it may be advantageous to store data in a dimensional database structure. Multi-dimensional database achieve performance levels that are well in excess of that of relational systems performing similar data storage requirements. These high performance levels encourage and enable On Line Analytical Processing (“OLAP”) and other such applications that can provide the ability to analyze large amounts of data with very fast response times.

Some implementations of the invention involve a dynamic ranking process, or at least a periodic ranking process. Accordingly, method 200 may continue (as determined in step 265) and re-rank and/or re-categorize a patron, even if there are no current patron event data of interest for that particular patron. (Step 230.)

Iterative patron ranking and/or categorization can be advantageous for several reasons. A patron exhibiting indications of wealth (e.g., an expensive car, jewelry, etc.) may not like to gamble, but may be visiting the casino for other reasons, e.g., to look around, to attend a performance, to meet a friend who is staying at the casino, etc. Accordingly, such a patron may not be interested in wager gaming or otherwise spending much money at the casino.

If such a patron had initially been selected as a “high roller” and placed in a resource-intensive category, a relatively large portion of the casino's available resources would have been directed towards monitoring the patron, populating a database with selected patron event data, providing special services, etc. It would be advantageous to re-categorize such patrons at a lower level if it subsequently becomes apparent that these patrons have less economic value to the casino than initially indicated.

Iterative patron ranking and/or categorization can solve this problem. For example, a high roller indicium may have been detected for a patron in step 210 or a defined event may have been determined in step 220. (See FIG. 2.) In step 230, this may have caused the patron to be ranked in category A or B. (See FIG. 3.) Therefore, a relatively high level of resources may have been directed towards the patron (as determined in step 235 of FIG. 2). Such resources may have included a relatively high level of service, targeted marketing, etc., as well as a relatively more detailed analysis of patron event data. (Step 240.) If the patron had been ranked at a high enough level, stored event data may also have been evaluated and selected. (Steps 250 and 255.) These data would be stored. (Steps 245 and 260.)

However, in this example it is subsequently determined that the patron was not providing much value to the casino. For example, it may have been determined that the patron had not spent or wagered more than a predetermined amount during a predetermined time. Therefore, during an iteration of step 230, the patron may be ranked and/or categorized at a lower level, e.g., as a category C or D patron.

As previously mentioned, special treatment may be accorded certain categories of patrons, e.g., patrons known to be “regulars,” patrons who are members of a player loyalty program, etc. For example, a patron who is a “platinum” level member might be categorized at least as a category B patron, even if the patron was not wagering or spending much on a particular day. On the other hand, a patron who cannot be identified and is not wagering or spending at a predetermined rate may be more quickly downgraded to a lower rank and/or category.

Accordingly, in some implementations of the invention, patron ranking is an iterative and/or a dynamic process. Resources will be directed to patrons (or not) according to their category, which may change over time, as well as other factors. To the extent that responses will be provided, they are preferably not only according to the patron's category, but also according to known preferences of the patron and/or information regarding the patron that may suggest such preferences, including but not limited to demographic data. For patrons who are identified, some such preference data may be determined from player loyalty and/or player tracking databases, other gaming establishment-related databases, or publicly available databases.

A casino may benefit not only from information gathered regarding high-value patrons, but also from information gathered regarding patrons that prove to have relatively little economic value to the casino. There may be, for example, “tell-tale” criteria, or combinations of criteria, that will negate otherwise reliable high-roller indicia and/or defined event determinations. Moreover, some high-roller or defined event criteria may be more likely than others to indicate a high-value patron. An iterative process of evaluating real-time patron event data may help to determine which high-roller or defined event criteria are relatively more or relatively less valid. Therefore, the casino may accrue long-term benefits if such patterns can be recognized.

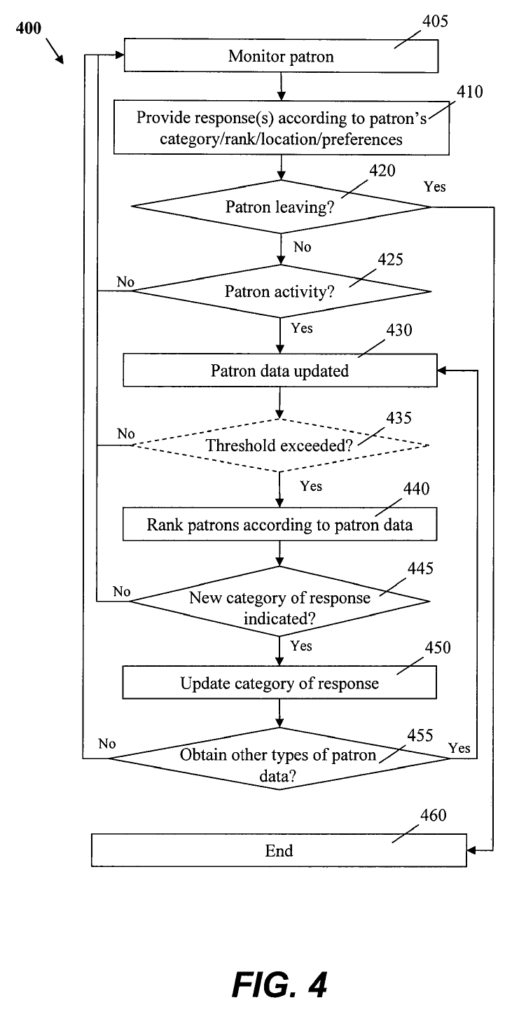

FIG. 4 outlines some steps of method 400, which indicates further details regarding a process of ranking and categorizing a patron according to some implementations of the invention. In step 405, a patron is being monitored. In this example, the patron has already entered a gaming establishment and has either been identified or at least has an assigned code or the like, in order to allow patron data to be associated with the patron and/or responses to be directed to the patron (step 410), if desired. The process ends (as to that patron) when a patron leaves. (Steps 420 and 465.)

In step 425, it is determined whether there has been some form of patron activity that may potentially affect a patron's rank and/or category. For example, the patron may have been observed shopping in an expensive shop, e.g., for high-end jewelry, watches, clothing, etc. An actual purchase of an expensive item, an expensive dinner, wine or other drinks, registering to stay in a luxury suite at the hotel, high-stakes wagering, or any other predetermined metric may cause a positive indication for step 425.

The patron's data will be updated, as appropriate. (Step 430.) In some implementations, a point-based system is applied to activities pertaining to step 425. In some such implementations, the number of points is proportional to the amount of money spent. Gaming and non-gaming activities may be treated as being equally significant in some implementations, but not in others. For example, a given amount wagered may be assigned a higher (or lower) point value than the same amount spent on a bottle of wine. In some implementations, even browsing in or near a high-end shop can result in the award of points.

In some implementations of the invention, the accumulated points may be loyalty points of a patron loyalty system, wherein points accumulated by patrons for both gaming and non-gaming activities may be redeemed upon demand by the patrons for goods and services. Such a program may be referred to herein as a “casino enterprise point system” or the like. Some implementations do not require patrons to enroll in a player loyalty program; points may be accumulated and redeemed anonymously. However, as noted above, such a program may include not only gaming and non-gaming activities in a particular gaming establishment, but also purchases (or other activities) in affiliated businesses at other sites. For gaming operators whose enterprises span multiple jurisdictions, the system should differentiate clearly unique jurisdictional requirements and isolate locations that do not allow certain types of promotions or features.

Preferably, points may be awarded in a flexible manner that may be tailored by a gaming establishment. A particular gaming establishment may choose to award more (or fewer) points for each dollar spent in a hotel or in a shop than wagered in a casino. For example, at certain times a gaming establishment may create incentives for patrons to patronize targeted portions of a casino. At such times, patrons may accumulate points in a particular shop, restaurant, entertainment venue, etc., at a higher rate than during other times. A gaming establishment may encourage participation in a jackpot or the like by allowing a patron to qualify for the jackpot by participating in various activities in addition to putting money in gaming machine, such as spending money in a retail location, buying a meal and/or a drink, making a purchase from a hotel room, playing a game from a hotel room, etc. A particular gaming establishment may desire to change point accumulation criteria based on various criteria, such as time of day, time of year (e.g., holidays), during special events (e.g., NASCAR weekend) or conferences, spend rates, patron rank/category, target spending criteria, etc.

According to method 400, each event that may change a patron's status may not necessarily trigger a re-assessment of patron ranking. In this example, it is determined whether a threshold is exceeded before such a re-ranking process is triggered. (See optional step 435.) The threshold may be relative (e.g., to a last point total of a patron) or absolute (e.g., with reference to “break points” between categories of patrons and/or levels of a player loyalty and/or player tracking program). The threshold(s) may be dynamically adjustable, e.g., to prevent re-ranking processes from being initiated too frequently when a gaming establishment is busy.

If such a threshold is exceeded, the patrons are re-ranked. In this example, there are multiple rankings within at least some categories (e.g., as described with reference to FIG. 3). Therefore, it is then determined whether the re-ranking process has resulted in a change in category for one or more patrons. (Step 445.) If so, the category is updated in step 450.

In step 455, it is determined whether other types of patron data are now desirable, in view of a change in patron category. For example, if a patron was previously in a lower category (e.g., category C or D of FIG. 3) and has been re-classified in a sufficiently higher category (e.g., category A or B of FIG. 3), it may now be worth making a more concerted effort to identify a patron and/or search databases for spending, preference and other information regarding the patron. If the patron has not previously been identified, a preliminary step may be the acquisition of additional identification data, e.g., additional biometric data. For example, image data suitable for a 3D facial recognition process may be acquired and the 3D facial recognition process may be invoked.

If additional patron data are acquired, they are associated with the patron and stored. (Step 430.) Such data may be used in both a monitoring process (step 405) and to determine appropriate responses for a patron. (Step 410.)

Patron data may be based on observations of the patron and/or the patron's activities. If a patron is seen to be wearing a hat or garment with a NASCAR-related logo, for example, offers relating to a NASCAR-related event may be directed to the patron. The degree to which such observations and/or responses are made will preferably be based upon a patron's category, in order to maintain a reasonable relationship between the resources directed towards the patron and the patron's likely value to the gaming establishment.

Some implementations involve tracking a patron's activities to determine various preferences, which may include gaming preferences or other preferences. For example, the time of day a patron likes to gamble, drink, shop, etc., what wagering games the patron prefers, etc., may be tracked. These data will provide information about what types of offers the patron may be interested in receiving at a particular time of day, day of the week, etc. Moreover, a patron's habits may also be used to verify a tentative identification based on other factors. For example, if there is a strong likelihood of a facial image match and other such data also match a patron's previously-observed habits, this provides a higher likelihood of a correct patron identification.

Gaming and/or non-gaming activity of all patrons may be monitored to some degree, even in implementations (such as that described with respect to FIG. 3) wherein no special response will be made to patrons having the lowest ranking. However, the degree of monitoring may vary considerably, e.g., according to a patron's category. A flexible approach to patron monitoring may be important, particularly if patrons cannot easily be monitored in a fully automated fashion, e.g., via an RFID network, by GPS, by triangulation (e.g., of a PDA, a cellular telephone or a mobile gaming device), by using a network of near-field magnetic devices, etc. Monitoring by facial recognition techniques may require a combination of automated processes and human involvement, and may therefore be quite resource-intensive.

More extensive and careful monitoring may be required for patrons in a high-level category: such patrons' location and/or activities may need to be closely monitored in order that a high level of service and other such resources are directed to the intended patrons. Such patrons may be monitored even by resource-intensive methods, if necessary.

In contrast, the level of “monitoring” for patrons in, e.g., category D of FIG. 3 may involve, e.g., only events that may indicate that a patron should be considered for a higher category. For example, if a category D patron were to order an expensive bottle of wine at restaurant 114, this may be considered a high roller indicium or a defined event and may trigger a re-evaluation of the patron's rank. However, in some implementations, even the activities and/or locations of category D patrons (or the like) will be tracked, e.g., if doing so will not consume a disproportionate level of resources. For example, if the locations of such patrons may be tracked by an RFID network, it may be done.

If it is determined that a patron is leaving the gaming establishment, the monitoring process may end. If so, the patron should no longer be included in a pool of patrons eligible for directed resources. The patron's ID may be removed from a list of patrons currently known to be in the gaming establishment. In some implementations, if the patron had been ranked, e.g., as a category “A” patron, the patron's departure could trigger a ranking of patrons still thought to be in the gaming establishment.

Some gaming networks described herein include a central system that is configured to download game software and data to networked gaming machines. The game theme of a particular networked gaming machine (or a group of networked gaming machines) may be changed according to instructions received from the central system. Such gaming networks allow for the convenient provisioning of networked gaming machines and allow additional game themes to be easily and conveniently added, if desired. Related software, including but not limited to game software, may be downloaded to networked gaming machines.

Relevant information is set forth in U.S. patent application Ser. No. 11/225,407 (Attorney Docket No. IGT1P237/P-1051), by Wolf et al., entitled “METHODS AND DEVICES FOR MANAGING GAMING NETWORKS” and filed Sep. 12, 2005, in U.S. patent application Ser. No. 10/757,609 by Nelson et al., entitled “METHODS AND APPARATUS FOR GAMING DATA DOWNLOADING” (Attorney Docket No. IGT1P213/P-657) and filed on Jan. 14, 2004, in U.S. patent application Ser. No. 10/938,293 by Benbrahim et al., entitled “METHODS AND APPARATUS FOR DATA COMMUNICATION IN A GAMING SYSTEM” (Attorney Docket No. IGT1P199/P-909) and filed on Sep. 10, 2004, in U.S. patent application Ser. No. 11/225,337 (Attorney Docket No. IGT1P185/P-1017) by Nguyen et al., filed Sep. 12, 2005 and entitled “DISTRIBUTED GAME SERVICES” and in U.S. patent application Ser. No. 11/173,442 (Attorney Docket No. IGT1P153/P-991) by Kinsley et al., filed Jul. 1, 2005 and entitled “METHODS AND DEVICES FOR DOWNLOADING GAMES OF CHANCE,” all of which are hereby incorporated by reference in their entirety and for all purposes. Some examples of gaming networks and devices are set forth below.

Example System Architecture

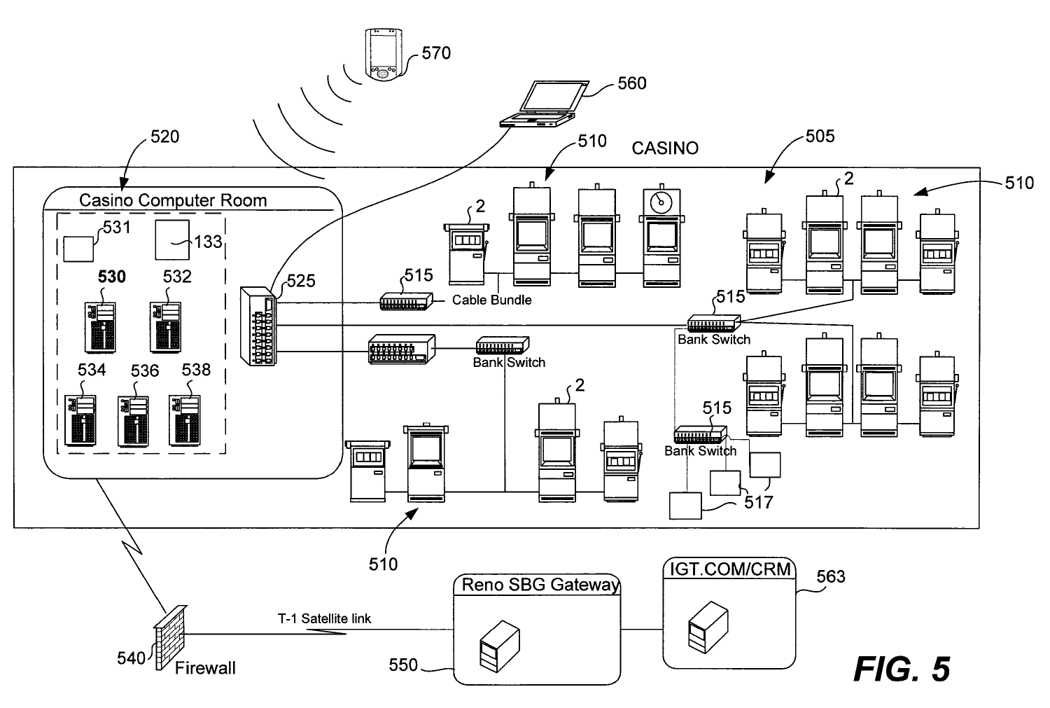

One example of a network topology for implementing some aspects of the present invention is shown in FIG. 5. Those of skill in the art will realize that this exemplary architecture and the related functionality are merely examples and that the present invention encompasses many other such embodiments and methods. Here, for example, a single gaming establishment 505 is illustrated, which is a casino in this example. However, it should be understood that some implementations of the present invention involve multiple gaming establishments.

Gaming establishment 505 includes 16 gaming machines 2, each of which is part of a bank 510 of gaming machines 2. In this example, gaming establishment 505 also includes a bank of networked gaming tables 517. It will be appreciated that many gaming establishments include hundreds or even thousands of gaming machines 2 and/or gaming tables 517, not all of which are included in a bank. However, the present invention may be implemented in gaming establishments having any number of gaming machines, gaming tables, etc.

Various alternative network topologies can be used to implement different aspects of the invention and/or to accommodate varying numbers of networked devices. For example, gaming establishments with very large numbers of gaming machines 2 may require multiple instances of some network devices (e.g., of main network device 525, which combines switching and routing functionality in this example) and/or the inclusion of other network devices not shown in FIG. 5. For example, some implementations of the invention include one or more middleware servers disposed between gaming machines 2 and server 530. Such middleware servers can provide various useful functions, including but not limited to the filtering and/or aggregation of data received from bank switches 515, from individual gaming machines and from other player terminals. Some implementations of the invention include load balancing methods and devices for managing network traffic.

Each bank 510 has a corresponding bank switch 515, which may be a conventional bank switch. Each bank switch is connected to server-based gaming (“SBG”) server 530 via main network device 525, which combines switching and routing functionality in this example.

Although various floor communication protocols may be used, some preferred implementations use the Game to System or “GS2” protocol. The GS2 protocol combines features of IGT's open, Ethernet-based SuperSAS® protocol and the Best of Breed (“BOB”) protocol, either of which may also be used to implement various aspects of SBG. IGT has also developed a gaming-industry-specific transport layer called CASH that rides on top of TCP/IP and offers additional functionality and security.

SBG server 530, License Manager 531, Arbiter 133, servers 532, 534, 536 and 538, and main network device 525 are disposed within computer room 520 of gaming establishment 505. In practice, more or fewer servers may be used. Some of these servers may be configured to perform tasks relating to player loyalty and/or player tracking, bonusing/progressives, etc. Some servers may be configured to perform tasks specific to the present invention. License Manager 531 may also be implemented, at least in part, via a server or a similar device. Some exemplary operations of License Manager 531 are described in detail in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., which is hereby incorporated by reference.

SBG server 530 can also be configured to implement, at least in part, various aspects of the present invention. Some preferred embodiments of SBG server 530 and the other servers shown in FIG. 5 include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 531, servers 532, 534, 536 and 538, and main network device 525) are mounted in a single rack with SBG server 530. Accordingly, many or all such devices will sometimes be referenced in the aggregate as an “SBG server.” However, in alternative implementations, one or more of these devices is in communication with SBG server 530 and/or other devices of the network but located elsewhere. For example, some of the devices could be mounted in separate racks within computer room 520 or located elsewhere on the network. For example, it can be advantageous to store large volumes of data elsewhere via a storage area network (“SAN”).

In some embodiments, these components are SBG server 530 preferably has an uninterruptible power supply (“UPS”). The UPS may be, for example, a rack-mounted UPS module.

Computer room 520 may include one or more operator consoles or other host devices that are configured for communication with SBG server 530. Such host devices may be provided with software, hardware and/or firmware for implementing various aspects of the invention; many of these aspects involve controlling SBG server 530. However, such host devices need not be located within computer room 520. Wired host device 560 (which is a laptop computer in this example) and wireless host device 570 (which is a PDA in this example) may be located elsewhere in gaming establishment 505 or at a remote location. Accordingly, one or more devices in casino 505 may be configured for communication with locations not limited to those indicated in FIG. 5, e.g., via the Internet or another convenient network.

Arbiter 133 may be implemented, for example, via software that is running on a server or another networked device. Arbiter 133 serves as an intermediary between different devices on the network. Some implementations of Arbiter 133 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation is discussed in the following paragraphs.

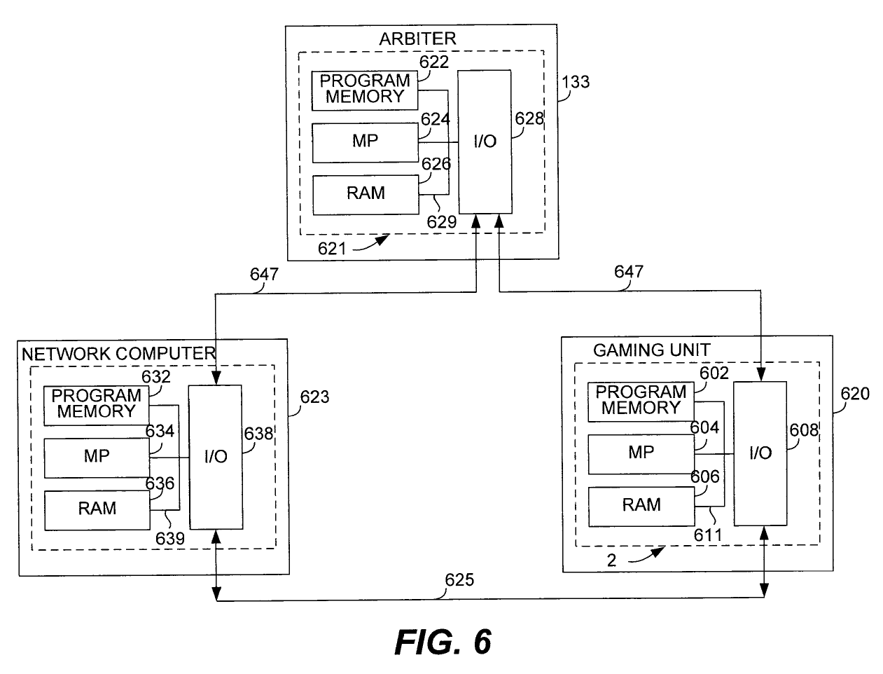

FIG. 6 is a block diagram of a simplified communication topology between a gaming unit 620, a network computer 623 and an Arbiter 133. Although only one gaming unit 620, one network computer 623 and one Arbiter 133 are shown in FIG. 6, it should be understood that the following examples may be applicable to different types of network gaming devices within the gaming network beyond the gaming unit 620 and the network computer 623, and may include different numbers of network computers 623, Arbiters 133 and gaming units 620. For example, a single Arbiter 133 may be used for secure communications among a plurality of network computers 623 and tens, hundreds or thousands of gaming units 620. Likewise, multiple Arbiters 133 may be utilized for improved performance and other scalability factors.

Referring to FIG. 6, the Arbiter 133 may include an arbiter controller 621 that may comprise a program memory 622, a microcontroller or microprocessor (MP) 624, a random-access memory (RAM) 626 and an input/output (I/O) circuit 628, all of which may be interconnected via an address/data bus 629. The network computer 623 may also include a controller 631 that may comprise a program memory 632, a microcontroller or microprocessor (MP) 634, a random-access memory (RAM) 636 and an input/output (I/O) circuit 638, all of which may be interconnected via an address/data bus 639. It should be appreciated that although the Arbiter 633 and the network computer 623 are each shown with only one microprocessor 624, 634, the controllers 621, 631 may each include multiple microprocessors 624, 634. Similarly, the memory of the controllers 621, 631 may include multiple RAMs 626, 636 and multiple program memories 622, 632. Although the I/O circuits 628, 638 are each shown as a single block, it should be appreciated that the I/O circuits 628, 638 may include a number of different types of I/O circuits. The RAMs 624, 634 and program memories 622, 632 may be implemented as semiconductor memories, magnetically readable memories, and/or optically readable memories, for example.

Although the program memories 622, 632 are shown in FIG. 6 as read-only memories (ROM) 622, 632, the program memories of the controllers 621, 631 may be read/write or alterable memories, such as hard disks. In the event a hard disk is used as a program memory, the address/data buses 629, 639 shown schematically in FIG. 6 may each comprise multiple address/data buses, which may be of different types, and there may be an I/O circuit disposed between the address/data buses.

As shown in FIG. 6, the gaming unit 2 may be operatively coupled to the network computer 623 via the data link 625. The gaming unit 2 may also be operatively coupled to the Arbiter 133 via the data link 647, and the network computer 623 may likewise be operatively coupled to the Arbiter 133 via the data link 647. Communications between the gaming unit 2 and the network computer 623 may involve different information types of varying levels of sensitivity resulting in varying levels of encryption techniques, depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), game download information (e.g., game software and game licensing information) and personal information (e.g., social security number, personal preferences, etc.) may be encrypted with stronger encryption techniques such as DES or 3DES to provide increased security.

As disclosed in further detail in the Arbiter Application, the Arbiter 133 may verify the authenticity of each network gaming device. The Arbiter 133 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts.

The Arbiter 133 may provide encryption keys (session keys) for the communication session to the client via the secure communication channel. Either the host and/or the session key may be provided in response to the request, or may have been previously provided. The client may contact the host to initiate the communication session. The host may then contact the Arbiter 133 to determine the authenticity of the client. The Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 133 may contact the host regarding the request and provide corresponding session keys to both the client and the host. The Arbiter 133 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Wireless devices are particularly useful for managing a gaming network. Such wireless devices could include, but are not limited to, laptops, PDAs or even cellular telephones. Referring once again to FIG. 5, one or more network devices in gaming establishment 505 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, etc., while on the casino floor.

If a host device is located in a remote location, security methods and devices (such as firewalls, authentication and/or encryption) should be deployed in order to prevent the unauthorized access of the gaming network. Similarly, any other connection between gaming network 505 and the outside world should only be made with trusted devices via a secure link, e.g., via a virtual private network (“VPN”) tunnel. For example, the illustrated connection between SBG 530, gateway 550 and central system 563 (here, IGT.com) that may be used for game downloads, etc., is advantageously made via a VPN tunnel.

An Internet-based VPN uses the open, distributed infrastructure of the Internet to transmit data between sites. A VPN may emulate a private IP network over public or shared infrastructures. A VPN that supports only IP traffic is called an IP-VPN. VPNs provide advantages to both the service provider and its customers. For its customers, a VPN can extend the IP capabilities of a corporate site to remote offices and/or users with intranet, extranet, and dial-up services. This connectivity may be achieved at a lower cost to the gaming entity with savings in capital equipment, operations, and services. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes.

There are many ways in which IP VPN services may be implemented, such as, for example, Virtual Leased Lines, Virtual Private Routed Networks, Virtual Private Dial Networks, Virtual Private LAN Segments, etc. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

As mentioned elsewhere herein, U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., describes novel methods and devices for authentication, game downloading and game license management. This application has been incorporated herein by reference.

Providing a secure connection between the local devices of the SBG system and IGT's central system allows for the deployment of many advantageous features. For example, a customer (e.g., an employee of a gaming establishment) can log onto an account of central system 563 (in this example, IGT.com) to obtain the account information such as the customer's current and prior account status.

Moreover, such a secure connection may be used by the central system 563 to collect information regarding a customer's system. Such information includes, but is not limited to, error logs for use in diagnostics and troubleshooting. Some implementations of the invention allow a central system to collect other types of information, e.g., information about the usage of certain types of gaming software, revenue information regarding certain types of games and/or gaming machines, etc. Such information includes, but is not limited to, information regarding the revenue attributable to particular games at specific times of day, days of the week, etc. Such information may be obtained, at least in part, by reference to an accounting system of the gaming network(s), as described in U.S. patent application Ser. No. 11/225,407 (Attorney Docket No. IGT1P237/P-1051), by Wolf et al., entitled “METHODS AND DEVICES FOR MANAGING GAMING NETWORKS,” which has been incorporated herein by reference.

Automatic updates of a customer's SBG server may also be enabled. For example, central system 563 may notify a local SBG server regarding new products and/or product updates. For example, central system 563 may notify a local SBG server regarding updates of new gaming software, gaming software updates, peripheral updates, the status of current gaming software licenses, etc. In some implementations of the invention, central system 563 may notify a local SBG server (or another device associated with a gaming establishment) that an additional theme-specific data set and/or updates for a previously-downloaded global payout set are available. Alternatively, such updates could be automatically provided to the local SBG server and downloaded to networked gaming machines.

After the local SBG server receives this information, it can identify relevant products of interest. For example, the local SBG server may identify gaming software that is currently in use (or at least licensed) by the relevant gaming entity and send a notification to one or more host devices, e.g., via email. If an update or a new software product is desired, it can be downloaded from the central system. Some relevant downloading methods are described elsewhere herein and in applications that have been incorporated herein by reference, e.g., in U.S. patent application Ser. No. 11/078,966. Similarly, a customer may choose to renew a gaming software license via a secure connection with central system 563 in response to such a notification.

Secure communication links allow notifications to be sent securely from a local SBG server to host devices outside of a gaming establishment. For example, a local SBG server can be configured to transmit automatically generated email reports, text messages, etc., based on predetermined events that will sometimes be referred to herein as “triggers.” Such triggers can include, but are not limited to, the condition of a gaming machine door being open, cash box full, machine not responding, verification failure, etc.

In addition, providing secure connections between different gaming establishments can enable alternative implementations of the invention. For example, a number of gaming establishments, each with a relatively small number of gaming machines, may be owned and/or controlled by the same entity. In such situations, having secure communications between gaming establishments makes it possible for a gaming entity to use a single SBG server as an interface between central system 563 and the gaming establishments.

As mentioned elsewhere herein some implementations of the invention involve aggregating data involving multiple patrons. In some such implementations, such data aggregations are used to determine patron “traffic patterns” and the like, including but not limited to determining what games targeted patrons prefer to play and when they prefer to play them. These data may be used to determine what games to enable in a given part of the casino during a given time period, thereby more nearly optimizing the deployment of games on the casino floor. By combining game preference data with patron preference and/or demographic data, offers and advertisements for the gaming, retail, beverage, restaurant, club and entertainment sectors of a gaming establishment may be more optimally directed to patrons of interest.

Some methods of the invention combine information that can be obtained from one or more gaming establishment databases with some of the SBG features described above. By combining, for example, information regarding scheduled gaming machine configurations and information regarding the amount of money that a gaming machine brings in while a gaming machine has a particular configuration, gaming machine configurations may be optimized to maximize revenue. Some such methods involve determining a first rate of revenue obtained by a gaming machine in the gaming network during a first time when the gaming machine has a first configuration. The gaming machine is later automatically configured according to second configuration information supplied by the SBG server, e.g., as scheduled by the Scheduler. A second rate of revenue, obtained by the gaming machine during a second time when the gaming machine has the second configuration, is determined, and so on.

After scheduling various configurations at various times, optimum configurations for the gaming machine may be determined for various times of day. The SBG system can them provide scheduled optimal configurations for the gaming machine at the corresponding times of day. Some implementations provide for groups (e.g., banks) of gaming machines to be automatically configured according to a predetermined schedule of optimal configurations for various times of day, days of the week, times of the year, etc.

In some such implementations, an average revenue may be computed, based on revenue from many gaming machines having the same configuration at the same time of day. These average revenues could be used to determine an overall optimal value for relevant time periods.

Some implementations of the invention control a gaming network in response to observed revenue obtained by gaming machines during different times and/or with different configurations. One such method includes these steps: determining a first rate of revenue obtained by a first gaming machine of a plurality of gaming machines in the gaming network during a first time when the first gaming machine has a first configuration; transmitting second configuration information to the first gaming machine via the gaming network; configuring the first gaming machine with a second configuration according to the second configuration information; and determining a second rate of revenue obtained by the first gaming machine during a second time when the first gaming machine has the second configuration.

The step of determining the first rate of revenue may involve receiving first revenue data from the first gaming machine via the gaming network, the first revenue data pertaining to the first time. In some implementations of the invention, when it is determined that the first rate of revenue is higher than the second rate of revenue, the method further comprises these steps: transmitting third configuration information to the first gaming machine via the gaming network; and configuring the first gaming machine with a third configuration according to the second configuration information. The second configuration information may be, for example, denomination information, display information, pay table percentage and/or game software information.

Another such method involves these steps: receiving revenue data from a first gaming machine of a plurality of gaming machines in the gaming network; determining a first rate of revenue obtained by the first gaming machine during a first time when the first gaming machine has a first configuration; determining a second rate of revenue obtained by the first gaming machine during a second time when the first gaming machine has a second configuration; determining an N^{th} rate of revenue obtained by the first gaming machine during an N^{th} time when the first gaming machine has an N^{th} configuration; and ascertaining a first optimum configuration for the first gaming machine during a first time of day. The first optimum configuration corresponds with a highest rate of revenue determined for the first gaming machine during the first time of day.

The method may also involve scheduling the first gaming machine to be automatically configured with the first optimum configuration during the first time of day. If the first gaming machine is part of a bank of gaming machines, the method may involve scheduling each gaming machine of the bank of gaming machines to be automatically configured with the first optimum configuration during the first time of day.

The method may include these steps: ascertaining a second optimum configuration for the first gaming machine during a second time of day, the second optimum configuration corresponding with a highest rate of revenue determined for the first gaming machine during the second time of day; and scheduling the first gaming machine to be automatically configured with the second optimum configuration during the second time of day.

The method may include the following steps: receiving revenue data from second through M^{th} gaming machines in the gaming network; determining a first average rate of revenue obtained by the second through M^{th} gaming machines during the first time when the second through M^{th} gaming machines have the first configuration; determining a second average rate of revenue obtained by the second through M^{th} gaming machines during a second time when the second through M^{th} gaming machines have a second configuration; determining an N^{th} average rate of revenue obtained by the second through M^{th} gaming machines during an N^{th} time when the second through M^{th} gaming machines have an N^{th} configuration; and ascertaining a first overall optimum configuration for the second through M^{th} gaming machines during a predetermined time of day. The first overall optimum configuration corresponds with a highest average rate of revenue determined for the second through M^{th} gaming machines during the predetermined time of day. The first optimum configuration may include a denomination, a display type, a pay table percentage and/or a game type.

Although the foregoing invention has been described in some detail for purposes of clarity of understanding, it will be apparent that certain changes and modifications may be practiced within the scope of the appended claims.

1. An image analyzing system, comprising:
a camera system comprising a plurality of cameras for obtaining patron data regarding people in or near a commercial establishment, the plurality of cameras configured for communication with other devices via a network; and
a server, comprising:
at least one network interface configured for communication with the network; and
a logic system configured to do the following:
acquire patron data regarding a patron from at least one of the cameras via the network interface;
categorize the patron with reference to the acquired patron data; and
determine, according to the categorization, whether to populate a customer loyalty database with at least some of the patron data.

2. The system of claim 1, wherein the logic system is further configured to cause a benefit to be provided to the patron according to a categorization.

3. The system of claim 1, wherein the logic system is further configured to do the following:
obtain stored patron data regarding the patron from a database; and
categorize the patron with reference to the acquired patron data and the stored patron data.

4. The system of claim 1, wherein the logic system determines the patron's expected economic value to the commercial establishment, and wherein the person is categorized, at least in part, according to the expected economic value.

5. The system of claim 1, wherein the camera system is configured for tracking patrons.

6. The system of claim 1, wherein the logic system comprises at least one processor.

7. The system of claim 1, further comprising a network of radio frequency identification readers configured to provide patron locations.

8. The system of claim 2, wherein the database is a customer loyalty system database.

9. The system of claim 4, wherein the logic system assigns a rank to the patron, the rank depending at least in part on the patron's expected economic value to the commercial establishment.

10. The system of claim 5, wherein the camera system further comprises means for handing off acquired patron data from a first range of a first camera to a second range of a second camera.

11. A method, comprising:
receiving real-time patron event data for patrons of a wager gaming establishment;
comparing the real-time patron event data with a set of defined events;
determining when a patron event of the real-time patron event data matches a defined event; and
causing real-time patron event data to be stored in a database of a player loyalty system of the wager gaming establishment, the real-time patron event data relating to a selected patron whose event matched a defined event.

12. The method of claim 11, further comprising retrieving, after the determining step, stored patron event data for the selected patron corresponding to a predetermined time interval prior to a time of the defined event, the stored patron event data comprising image data.

13. The method of claim 11, further comprising:
associating patron event data that occurred prior to a time of the defined event with the selected patron; and
storing data associated with the selected patron in the database of the player loyalty system.

14. The method of claim 11, wherein the real-time patron event data stored in the database correspond to patron events that occur after a time of the defined event.

15. The method of claim 11, wherein the real-time patron event data comprise image data.

16. The method of claim 11, wherein the set of defined events comprise indicia of patrons with expected economic value to the wager gaming establishment.

17. The method of claim 11, wherein the determining step comprises determining that a patron's wagering or coin in has exceeded a predetermined threshold.

18. The method of claim 11, wherein the determining step comprises determining that a member of the player loyalty system has initiated a wager gaming session.

19. The method of claim 11, further comprising associating a code with a patron whose event matches a defined event.

20. The method of claim 11, further comprising:
determining when the patron event data matches a benefit event associated with providing a benefit to the patron; and
sending a signal to a device via the interface system, the signal indicating a benefit to be provided to the patron.

21. The method of claim 12, further comprising:
receiving selected patron event data that have been selected from the stored patron event data; and
causing selected patron event data to be stored in the database of the player loyalty system.

22. The method of claim 18, wherein the determining step comprises determining that the member has attained at least a predetermined level of the player loyalty system.

23. A method of processing image data, comprising:
acquiring image data of people in or near a commercial establishment;
analyzing the image data according to a first rule set;
determining whether a person is a member of a customer loyalty program; and
analyzing the image data according to a second rule set when it is determined that the person is a member of the customer loyalty program.

24. The method of claim 23, wherein the customer loyalty system comprises a card-based player tracking system of a wager gaming establishment and wherein the determining step comprises determining when the person's player loyalty card has been inserted into a wager gaming machine.

25. The method of claim 23, wherein analyzing the image data according to the second rule set comprises a more detailed analysis of stored image data acquired prior to a time at which it was determined that the person is a member of the customer loyalty program.

26. The method of claim 23, wherein at least one of the rule sets involve one or more of wagering indicia, clothing indicia, jewelry indicia, personal association indicia, tipping indicia and purchasing indicia.

27. The method of claim 23, further comprising tracking the person's location while the person is within, or in the vicinity of, the commercial establishment.

28. The method of claim 23, further comprising populating a data file regarding the member of the customer loyalty program according to the image data.

29. An apparatus, comprising:
an interface system;
a memory having a data structure stored therein, the data structure indicating a set of defined events;
a logic system configured to do the following:
receive real-time patron event data via the interface system;
compare the real-time patron event data with the set of defined events;
determine when a patron event of the real-time patron event data matches a defined event; and
cause real-time patron event data to be stored in a database of a customer loyalty system, the real-time patron event data relating to a selected patron whose event matched a defined event.

30. The apparatus of claim 29, wherein the logic system is further configured to retrieve, after the determining step, stored patron event data for the selected patron corresponding to a predetermined time interval prior to a time of the defined event, the stored patron event data comprising image data.

31. The apparatus of claim 29, wherein the logic device is configured to do the following:
associate patron event data that occurred prior to a time of the defined event with the selected patron; and
store data associated with the selected patron in the database of the customer loyalty system.

32. The apparatus of claim 29, wherein the real-time patron event data stored in the database correspond to patron events that occur after a time of the defined event.

33. The apparatus of claim 29, wherein the real-time patron event data comprise image data.

34. The apparatus of claim 29, wherein the set of defined events comprise indicia of patrons with expected economic value to a commercial establishment.

35. The apparatus of claim 29, wherein the determining step comprises determining that a patron's wagering or coin in has exceeded a predetermined threshold.

36. The apparatus of claim 29, wherein the determining step comprises determining that a member of the customer loyalty system has initiated a wager gaming session.

37. The apparatus of claim 29, wherein the logic system is further configured to associate a code with a patron whose event matches a defined event.

38. The apparatus of claim 29, wherein the logic system is further configured to do the following:
determine when the patron event data matches a benefit event associated with providing a benefit to the patron; and
send a signal to a device via the interface system, the signal indicating a benefit to be provided to the patron.

39. The apparatus of claim 30, wherein the logic system is further configured to do the following:
receive selected patron event data that have been selected from the stored patron event data; and
cause selected patron event data to be stored in the database of the customer loyalty system.

40. The apparatus of claim 36, wherein the determining step comprises determining that the member has attained at least a predetermined level of the customer loyalty system.

41. A system for processing image data, comprising:
means for acquiring image data of people in or near a commercial establishment;
means for analyzing the image data according to a first rule set;
means for determining whether a person is a member of a customer loyalty program; and
means for analyzing the image data according to a second rule set when it is determined that the person is a member of the customer loyalty program.

42. The system of claim 41, wherein the customer loyalty program is implemented, at least in part, via a card-based player tracking system and wherein the determining means comprises means for determining when the person's player loyalty card has been inserted into a wager gaming machine.

43. The system of claim 41, wherein the means for analyzing the image data according to the second rule set performs a more detailed analysis of stored image data acquired prior to a time at which the determining means determines that the person is a member of the customer loyalty program.

44. The system of claim 41, wherein at least one of the rule sets involves one or more of wagering indicia, clothing indicia, jewelry indicia, personal association indicia, tipping indicia and purchasing indicia.

45. The system of claim 41, further comprising means for tracking the person's location while the person is within, or in the vicinity of, the commercial establishment.

46. The system of claim 41, further comprising means for populating a data file regarding the member of the customer loyalty program according to the image data.

47. A method of analyzing images, comprising:
acquiring patron data regarding a patron from at least one of a plurality of cameras in a commercial establishment;
categorizing the patron with reference to the acquired patron data; and
determining, according to the categorization, whether to populate a customer loyalty database with at least some of the patron data.

48. An apparatus for analyzing images, comprising:
means for acquiring patron data regarding a patron from at least one of a plurality of cameras in a commercial establishment;
means for categorizing the patron with reference to the acquired patron data; and
means for determining, according to the categorization, whether to populate a customer loyalty database with at least some of the patron data.

49. An image analyzing system, comprising:
a plurality of cameras for obtaining patron data regarding people in or near a commercial establishment, the cameras configured for communication with other devices via a network; and
a server, comprising:
at least one network interface configured for communication with the network; and
a logic system configured to do the following:
acquire patron data regarding a patron from at least one of the cameras via the network interface;
categorize the person with reference to the acquired patron data; and
determine whether to provide a benefit to the person according to a categorization.

50. The system of claim 49, wherein at least one logic device is further configured to do the following:
obtain stored patron data regarding the patron from a database; and
categorize the patron with reference to the acquired patron data and the stored patron data.

51. The system of claim 49, wherein at least one logic device determines the patron's expected economic value to the commercial establishment, and wherein the person is categorized, at least in part, according to the expected economic value.

52. The system of claim 49, further comprising means for tracking the patron's location while the person is within, or in the vicinity of, the commercial establishment, the tracking means comprising means for communicating the person's location via the network.

53. The system of claim 49, wherein the acquired patron data comprise facial image data.

54. The system of claim 51, wherein the logic system assigns a rank to the patron, the rank depending at least in part on the patron's expected economic value to the commercial establishment.

55. The system of claim 52, wherein the tracking means comprises a radio frequency identification network.

56. A method, comprising:
acquiring patron data from at least one of a plurality of cameras;
categorizing a patron of a business with reference to the acquired patron data; and
determining whether to provide a benefit to the patron according to a categorization.

57. The method of claim 56, further comprising:
obtaining stored patron data regarding the patron from a database; and
categorizing the patron with reference to the acquired patron data and the stored patron data.

58. The method of claim 56, wherein the categorizing step comprises determining the patron's expected economic value to the business.

59. The method of claim 56, further comprising tracking the patron's location.

60. The method of claim 56, wherein the acquired patron data comprise facial image data.

61. The method of claim 56, further comprising ranking the patron based, at least in part, on the patron's expected economic value to the business.

62. A system for processing image data, comprising:
a camera system configured for acquiring image data of people in or near a business;
a logic system configured to perform the following tasks:
analyze the image data according to a first rule set;
determine whether a person is a member of a customer loyalty program; and
analyzing the image data according to a second rule set when it is determined that the person is a member of the customer loyalty program.

63. The system of claim 62, wherein the image data comprise facial image data and wherein the logic system is configured to identify the person according to the facial image data.
